(19) United States
(12) Patent Application Publication
(10) Pub. No.: US 2008/0000091 A1
(43) Pub. Date: Jan. 3, 2008

(54) Threaded Rod Cutter

(75) Inventor: Tatsumi Eriguchi, Nara (JP)

Correspondence Address: Michael Fedrick;Sheldon & Mak, 225 S. Lake Ave., 9th Floor, Pasadena, CA, 91101, US

(73) Assignee: Toho Koki Co., Ltd., Nara (JP)

(21) Appl. No.: 11/427,676

(22) Filed: Jun. 29, 2006

(51) Int. Cl. B26D 1/00; B26B 27/00

(52) U.S. Cl. 30/90.1; 83/692; 83/694; 30/92

(57) ABSTRACT

A rod cutter having multiple sets of cutting dies for cutting threaded rods of varying sizes is described.

### BACKGROUND

Threaded rods are commonly used in a variety of construction projects and may be used to secure pipe, conduit sprinklers systems, duct work, lighting, ceiling and other construction components. They must usually be cut to a particular size, sometimes on site. For this purpose, saws, cut-off machines, and other special cutting devices are used. When employing saws and cut-off machines, the cut end of the thread may be deformed or a burr created. These resulting defects make the task of screwing a nut onto the threaded rod much more difficult.

Other cutting devices involve the use of two actuating levers which are provided at their free end with a cutting jaw for cutting a threaded rod. Such cutting devices can also create a burr or deformation at the end of the thread, and are relatively large and unwieldy. Since construction projects often require the incorporation of threaded rods of varying size or diameter, workers must either use multiple cutting devices of this type or spend time swapping out different cutting dies when they need to cut or crop differently sized threaded rods.

### SUMMARY

A cutting device is disclosed for cutting or cropping rods, in particular externally threaded rods. In one preferred embodiment, the device includes a horizontal main base operable to accept a pipe plate extending horizontally from the main base. An adaptor or arm receiving cam operable to receive a handle is coupled to the main base such that the rotation of the handle engages and rotates the adaptor. The cutting device further comprises first and second die holders, having receptacles for holding dies. Each such receptacle on the first die holder is associated with a corresponding receptacle on the second die holder such that a receptacle on the first die holder secures a first half of a die set and the corresponding receptacle on the second die holder secures the matching second half of that die set. The first die holder is coupled to the adapter and the second die holder is coupled to the main base, such that the rotation of the handle engages the adapter and causes the first die holder to rotate relative to the stationary second die holder. The rotation of the handle thereby moves the associated receptacles of the two die holders into a substantially open or closed position. As a result, a threaded rod can be disposed within a pair of corresponding receptacles and cut along the line defined by the interface of the receptacles.

### DRAWINGS

These and other features, aspects and advantages of the present invention will become better understood with regard to the following description, appended claims, and accompanying figures, where:

FIG. 1A is a side plan view of an exemplary embodiment of the present rod cutter;

FIG. 1B is a top plan view of the rod cutter of FIG. 1A;

FIG. 1C is an exploded view of the rod cutter of FIG. 1A;

FIG. 1D is a side plan view of the cutting portion of the rod cutter of FIG. 1A in which the die holder receptacles are in a closed position;

FIG. 1E is a side plan view of the portion of the present rod cutter shown in FIG. 1D showing the die holder receptacles in an open position;

FIG. 2A is a perspective view of the embodiment of the present rod cutter of FIG. 1A showing a rod disposed within a first pair of open receptacles of the rod cutter;

FIG. 2B is a perspective view of the embodiment of the present rod cutter of FIG. 1A showing a rod disposed within a second pair of open receptacles;

FIG. 3A is a side plan view of a second exemplary embodiment of the present rod cutter;

FIG. 3B is a top plan view of the rod cutter of FIG. 3A; and

FIG. 3C is an exploded view of the rod cutter of FIG. 3A.

All dimensions specified in this disclosure are by way of example only and are not intended to be limiting. Further, the proportions shown in these Figures are not necessarily to scale. As will be understood by those with skill in the art with reference to this disclosure, the actual dimensions of any device or part of a device disclosed in this disclosure will be determined by their intended use.

### DESCRIPTION

The present invention provides a portable rod cutter that can incorporate multiple cutting die sets to allow a user to selectively cut rods of varying sizes. The rod cutter comprises first and second die holders, which each have multiple receptacles. The receptacles on the first die holder secure a first half of a cutting die set and the corresponding receptacle on the second die holder secures the matching second half of that cutting die set. The first die holder can rotate relative to the second die holder to move the associated receptacles of the two die holders into a substantially open or closed position. Accordingly, a threaded rod can be disposed within a pair of receptacles and cut along the line defined by the interface of the receptacles.

Prior art cutting tongs require that a pair of pivot levers be pressed together to move two cutting jaws apart to allow insertion of a rod and that the pivot levers then be moved apart to cause the two cutting jaws to cut the rod. In contrast, the rod cutter of the present invention utilizes a single force multiplying lever in which the rotation of the lever provides a corresponding rotation of a first die holder relative to a second die holder to move the jaws of the dies into an open or closed position to receive or cut a rod, respectively. As a result, the present invention provides a mechanical advantage to facilitate cutting, provides easier and faster use (e.g., the cutting takes place directly without a prior operation to secure or introduce the rod), and allows for a smaller work space, among other advantages.

In addition, by incorporating multiple cutting dies, a user can operate the present rod cutter to cut or crop cylindrical threaded work pieces of varying sizes without resorting to using an additional cutting tool or interrupting the work process to replace cutting dies each time the user needs to cut a rod of a different size. Accordingly, workers can cut or crop threaded rods more efficiently and with fewer interruptions. The rod cutter is also operable to receive interchangeable sets of dies to accommodate threaded rods having different diameters. The present invention also cuts threaded rods quickly, cleanly and precisely, without forming burrs or other defects. As a result, the user can incorporate the threaded rods into other work pieces without grinding or filing the cut surfaces.

### DEFINITIONS

As used herein, the following terms and variations thereof have the meanings given below, unless a different meaning is clearly intended by the context in which such term is used.

“Rod” refers to substantially cylindrical work pieces.

“Threaded rod” refers to a rod incorporating a projecting helical rib by which work pieces can be screwed together, including, but not limited to, externally threaded cylindrical work pieces. Typically, threaded rods are made from soft steel or similar materials.

As used herein, the term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise.

### Rod Cutter

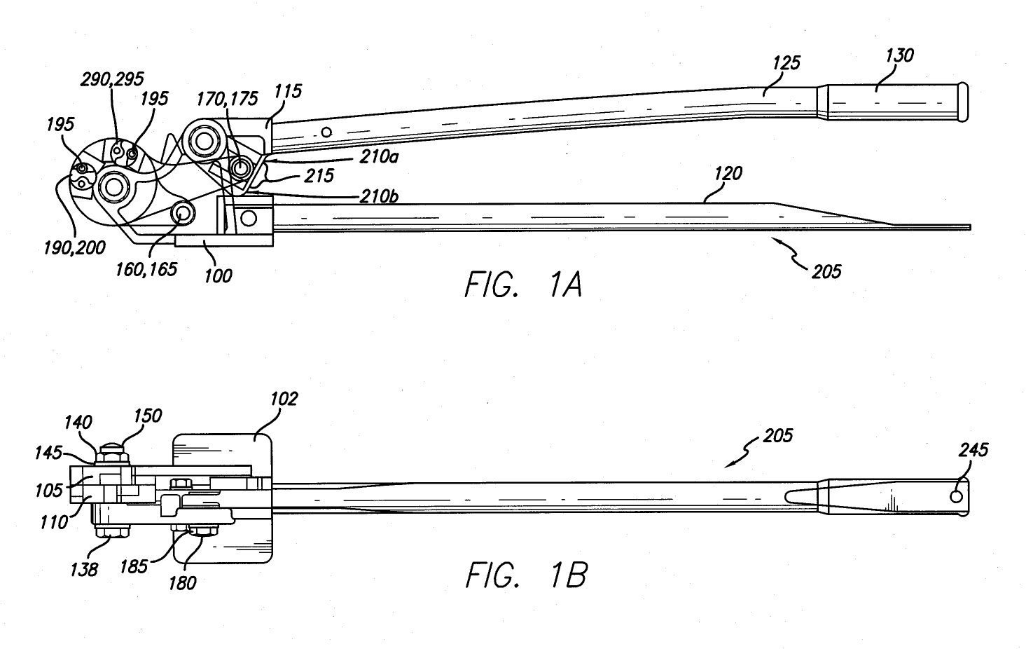

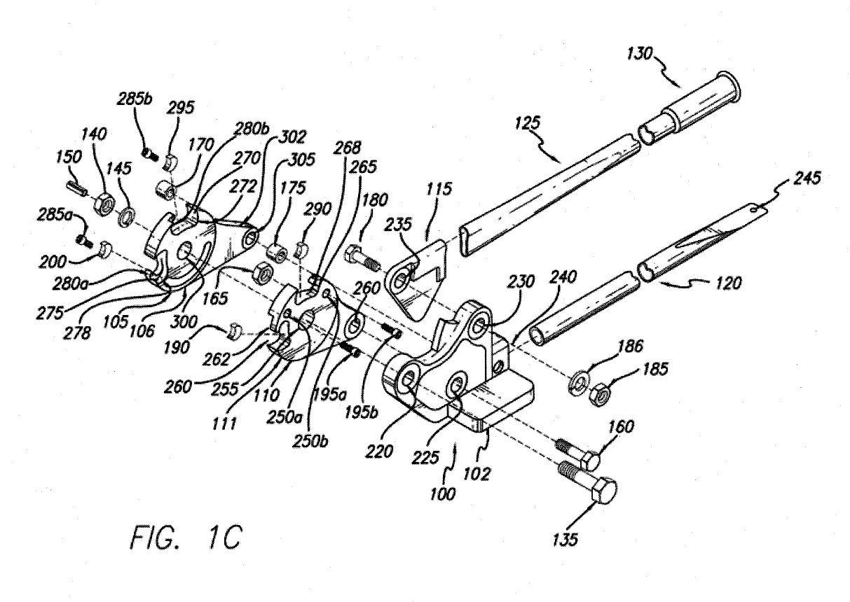

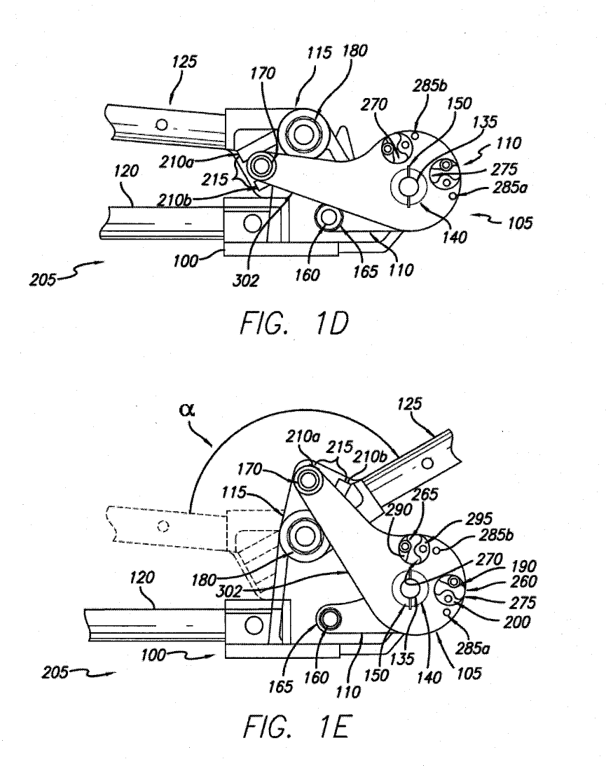

Referring to FIGS. 1A-C, rod cutter (205) comprises a main base (100). Main base (100) preferably comprises a plate (102) to allow rod cutter (205) to be placed on a work surface for operation and to provide stability. Plate (102) can also include mounting holes to allow permanent or temporary mounting to a work or storage surface. Main base (100) can be coupled to a first die holder (105), a second die holder (110), an adapter or arm receiving cam (115) and a pipe plate (120). As shown in FIG. 1C, main base (100) comprises clearance holes (220), (225) and (230) to allow main base (100) to be coupled to the other components of the rod cutter (205). The clearance holes (220), (225) and (230) which can be threaded or unthreaded holes, receive bolts (135), (160), and (180), respectively. While bolts are exemplified in the drawings and the foregoing description, other fasteners known to the art can also be used.

As shown in FIGS. 1A and 1B, a pipe plate (120) can be included to provide additional stability and leverage during operation of the rod cutter (205). The pipe plate (120) preferably extends horizontally i.e., parallel to a support surface, from main base (100) when supported on a support surface, such as a table, bench or the ground. Pipe plate (120) can include mounting hole (245) to allow permanent or temporary mounting of the rod cutter (205) to a support surface.

As shown in FIG. 1C, adapter (115) can be coupled to handle (125), though the handle (125) can alternatively be directly coupled to the main base (100). Handle (125) can comprise grip (130) to provide comfortable operation. The adapter (115) comprises a clearance hole (235) sized to receive bolt (180), whereby bolt (180) can be inserted through clearance holes (235) and (230) and secured by nut (185) and washer (186) to couple the adapter (115) to main base (100) and thereby form a bolted joint at the interface between the adapter (115) and the main base (100). Thus, the rotation of handle (125) rotates adapter (115) about axis (240). As shown in FIG. 1A, the outer side of adapter (115) comprises ridges (210a, 210b), which form groove (215).

Referring to FIG. 1C, a first die holder (105) comprises a circular portion (106), with receptacles (275) and (270) being positioned around the periphery of this circular portion (106). The receptacle (275) comprises a slot (278) operable to receive a first cutting die (200). Receptacle (270) likewise comprises a slot (272) operable to receive a second cutting die (295). The first die holder (105) can comprise sockets (280a) and (280b), which are operable to receive hexagon socket head cap screws (285a) and (285b), respectively. The cutting dies (200) and (295) can be secured to the receptacles (275) and (270) by inserting screws (285a) and (285b) into sockets (280a) and (280b), respectively. Cutting dies (200) and (295) are thus reversibly secured to the receptacles and can be easily fastened or removed. As discussed below, cutting die (200) and cutting die (190) together form a die set. Similarly, cutting dies (295) and (290) form a die set.

The first die holder (105) further comprises a pivot arm (302) and clearance holes (300) and (305). Clearance hole (300) is sized to receive bolt (135), and clearance hole (305) is sized to receive roller pin (170). Roller pin (170) is sized to couple with roller (175), and roller (175) is sized to couple with groove (215), such that roller (175) is able to move smoothly along groove (215) when the adapter (115) rotates.

The second die holder (110), like the first die holder (105), comprises a circular portion (111), and receptacles (260) and (265) are positioned around the periphery of circular portion (111). The receptacle (260) comprises a slot (262) operable to receive a cutting die (190), and receptacle (265) comprises a slot (268) operable to receive cutting die (290). The second die holder (110) can comprise sockets (250a) and (250b), which are operable to receive hexagon socket head cap screws (195a) and (195b), respectively. Accordingly, dies (190) and (290) can be secured to the second die holder (110) by inserting screws (195a) and (195b) into sockets (250a) and (250b), respectively. Cutting dies (190) and (290) are thus also reversibly secured to receptacles of the present rod cutter and can be easily fastened or removed. The second die holder (110) further comprises clearance holes (255) and (260). Clearance holes (255) and (260) may be threaded or clear holes, and are sized to receive bolts (135) and (160), respectively. While bolts are exemplified in the drawings and the foregoing description, other fasteners known to the art can also be used.

The second die holder (110) can be coupled to the main base (100) by inserting bolt (160) through clearance holes (225) and (260) and securing bolt (160) with nut (165). The first die holder (105) can be coupled to the second die holder (110) and main base (100) by inserting bolt (135) through clearance holes (220), (255) and (300) and securing bolt (135) with nut (140), washer (145) and spring pin (150). In this manner, circular portions (106) and (111) are rotatably coupled to form a circular assembly in which the receptacles (260, 265 270 and 275) of the first and second die holders (105, 110) are positioned around the periphery of this circular assembly.

FIGS. 1D and 1E show a side view of the rod cutter (205) (from the side opposite that shown in FIG. 1A). In FIG. 1D, the handle (125) is in a substantially horizontal “rest” position. In this embodiment, when handle (125) is in this position, the receptacles (270) and (265) are positioned with respect to each other such that dies (290) and (295) are in a closed position, i.e., dies (290) and (295) overlap or are in close enough proximity such that a rod cannot be disposed between them. Similarly, receptacles (260) and (275) are positioned with respect to each other such that dies (190) and (200) are in a closed position.

FIG. 1E shows the configuration of the various components of the rod cutter (205) shown in FIG. 1D after the handle (125) has been rotated by an angle a about axis (240) (see FIG. 1C). The first die holder (105) is coupled to the adapter (115) via pivot arm (302), roller (175) and roller pin (170). The rotation of handle (125) about axis (240) engages the adapter (115) and causes the first die holder (105), via pivot arm (302) and roller (175), to move relative to the second die holder (110). Accordingly, the receptacles (270) and (265) of the first and second die holders (105) and (110), respectively, move relative to each other such that the rod engagement surfaces of dies (290) and (295) move further apart and into a substantially open position. The rotation of handle (125) simultaneously moves receptacles (275) and (260) of the first and second die holders (105) and (110), respectively, such that the rod engagement surfaces of dies (190) and (200) move further apart and into a substantially open position. Thus, when the handle (115) is rotated, the die holders are opened and an appropriately sized threaded rod can be placed into either receptacles (270) and (265) or into receptacles (275) and (260).

Although the embodiment shown in FIGS. 1A-1E is a “double-die” rod cutter, the present invention is not limited to a rod cutter containing two die sets. In view of the present disclosure, one of ordinary skill in the art will understand that other embodiments of the present invention can incorporate more than two die sets. For example, a third pair of receptacles can be positioned on the periphery of circular portions (106) and (111) in order to incorporate a third die set. Due to the advantageous design of the present rod cutter, the present rod cutter (205) can incorporate multiple die sets to cut differently sized rods.

### Rod Cutter Operation

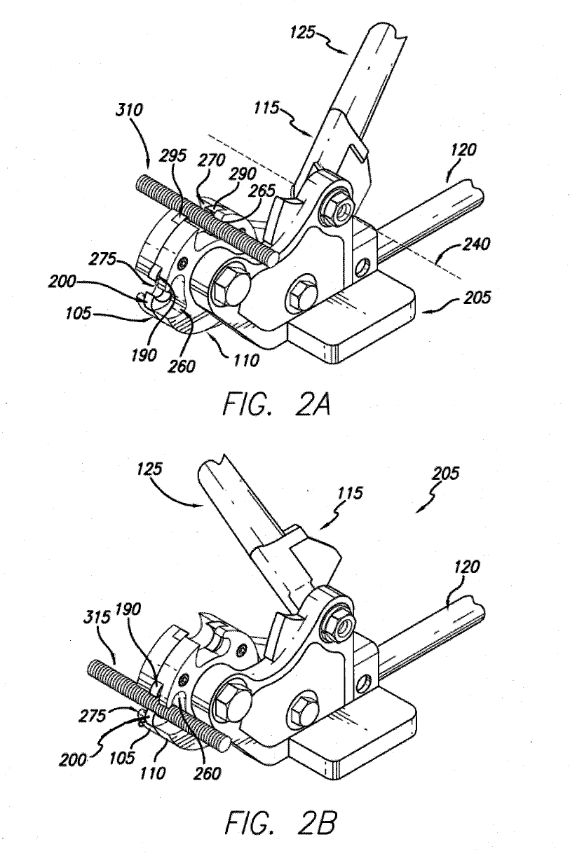

The operation of the present rod cutter (205) is illustrated in FIGS. 2A and 2B. This embodiment is a “double-die” rod cutter and comprises two cutting die sets. The first die set comprises dies (200) and (190), with the second die set comprising dies (290) and (295). The dies can be made from any suitable material capable of cutting a rod and are preferably made from a heat treated metal. Each die (190, 200, 290 and 295) can comprise a rod engagement surface that is shaped and sized to interface with the outer surface of an appropriately sized rod. For purposes of cutting an externally threaded rod, the engagement surface of each die in a selected die set can comprise grooves that match the thread of the externally threaded rod. Accordingly, when the threaded rod is inserted in the rod cutter, the threads of the threaded rod fit into the corresponding grooves of the engagement surfaces of the dies, such that the dies engage the rod in an interlocking manner. Generally, each die set is sized and threaded to accommodate a rod having a predetermined diameter and/or thread configuration. For example, a die set can be sized to fit with and cut standard ¼″, 5/16″, ⅜″ or ½″ threaded rods. The user of the rod cutter (205) preferably selects two die sets to cut two different sizes of threaded rods in order to be able to cut a series of rods of either size without having to replace the die sets or use a different tool.

FIG. 2A shows the rod cutter (205) being used to cut a threaded rod (310) with dies (290) and (295) which are sized to engage and cut the threaded rod (310). As discussed above in connection with FIG. 1E, the handle (125) can be rotated to cause the first die holder (105) to rotate relative to the second die holder (110) until receptacles (265) and (270) are aligned or positioned such that the engagement surfaces of dies (290) and (295) are moved sufficiently apart to form a slot that allows the threaded rod (310) to be disposed within both receptacles (265) and (275). The threaded rod (310) can be directly placed within receptacles (265) and (270) such that the region to be cut is properly aligned along the line defined by the interface of the receptacles (265) and (270) and/or the interface of the two dies of a die set. A user can then rotate handle (125) toward the pipe plate (120) as shown in FIG. 1D, to cause the first die holder (105) to rotate relative to the second die holder (110), such that the engagement surfaces of dies (290) and (295) are moved towards each other to couple with threaded rod (310) and then continue to move to a closed position in order to shear or cut the threaded rod (310) along the line defined by the interface the dies (290) and (295) when in a closed, overlapping position, which in this embodiment also corresponds to the interface of the receptacles (265) and (270). As shown in FIGS. 1D and 1E, the adapter (115) translates the relatively wider angle of rotation of handle (125) to the smaller rotation of the first die holder (105) to confer a mechanical advantage.

A user can then use the present rod cutter (205) to cut a threaded rod (315) of a different diameter, as shown in FIG. 2B, without changing die sets. The handle (125) can be rotated to cause the first die holder (105) to rotate relative to second die holder (110) as described above until receptacles (260) and (275) are aligned such that dies (190) and (200) are moved sufficiently apart to form a slot to allow the threaded rod (315) to be disposed within both receptacles (260) and (275). The user can then rotate the handle (125) back toward the pipe plate (120) to cause the first die holder (105) to rotate relative to the second die holder (110), such that the engagement surfaces of the dies (190) and (200) are moved towards each other to couple with the threaded rod (315) and then to continue to move towards a closed position. As a result, the threaded rod (315) disposed within receptacles (260) and (275) is sheared or cut.

In the event that the operator needs to cut a threaded rod of a different size than can be accommodated by one of the die sets installed in the rod cutter (205), or if one of the installed dies becomes damaged, a die set can be easily replaced or changed. First, the user removes the screws or other fasteners securing the dies of the installed die set to the die holders. The user then installs the new die set. Each die of the die set must be placed in the appropriate slot, in embodiments in which the dies of a die set are not interchangeable. For example, if the user is replacing the die set (290) and (295), the user must ensure that new die (290) is placed in die slot (268) of receptacle (265) and new die (295) is placed in die slot (272) of receptacle (270). The user installs screws (285b) and (195b) but preferably does not tighten them at this point. The user can then place an appropriately sized threaded rod in the cutting position to ensure that the thread of the rod matches and aligns with the engagement surfaces of both dies. Once the user is satisfied, screws (285b) and (195b) can be tightened and secured. Generally, each die of a die set is matched with a corresponding die as a set and cannot be mixed together with another die. Typically, when a die is damaged or defective, the user must change both dies in the set.

### Alternative Rod Cutter

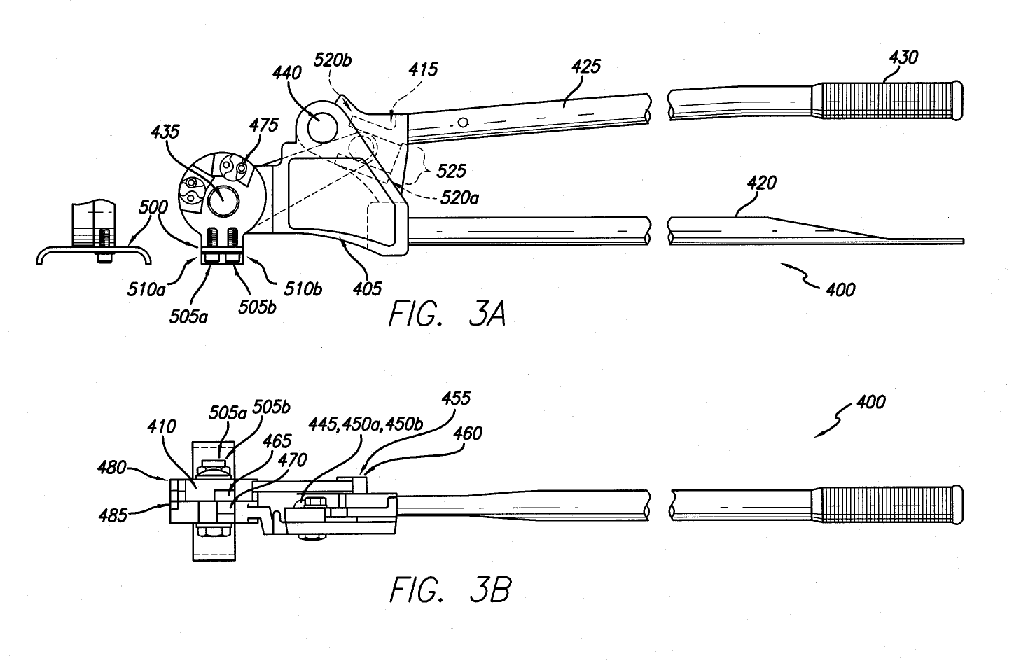

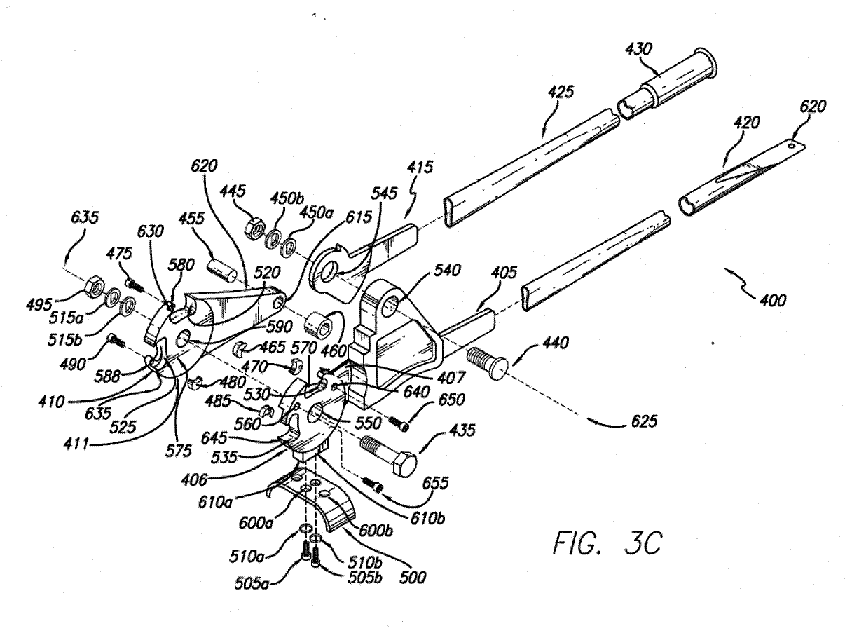

FIGS. 3A-C depict another exemplary embodiment of the present invention. In this embodiment, the rod cutter (400) is a “double-die” threaded rod cutter. Rod cutter (400) comprises a first die holder (410), an adapter (415), a second die holder (405), a handle (425), a pipe plate (420) and a main base (500). The rod cutter (400) is similar to the rod cutter (205) depicted in FIGS. 1A-2B, except that the main base (100) serves as a central component for rod cutter (205), while the second die holder (405) serves as the central component for rod cutter (400), e.g., a component to which every other main component of the rod cutter is connected.

As shown in FIG. 3C, the second die holder (405) can be coupled with the pipe plate (420) and the main base (500) to allow rod cutter (400) to be placed on a work surface and provide stability during operation. The second die holder (405) comprises sockets (610a) and (610b) that are operable to accept hexagon socket head screws (505a) and (505b). Main base (600) comprises apertures (600a) and (600b) that are sized to receive the threaded portions of hexagon socket head cap screws (505a) and (505b). Accordingly, hexagon socket head cap screws (505a) and (505b), preferably coupled to washers (510a) and (510b), can be used to couple main base (500) to the second die holder (405). The pipe plate (420) can include mounting hole (620) to allow permanent or temporary mounting of the rod cutter (400) to a work or storage surface.

The adapter (415) and second die holder (405) comprise clearance holes (545) and (540), respectively, which are sized to receive bolt (440). Bolt (440) can couple adapter (415) to the second die holder (405) and can be secured by nut (445) and lock washers (450a) and (450b). The adapter (415) is operable to couple with the handle (425), which can comprise grip (430). The rotation of the handle (425) about axis (625) engages and rotates the adapter (415) about axis (635).

The first die holder (410) and second die holder (405) comprise holes (590) and (550), respectively, operable to receive a bolt (435). The bolt (435) can couple the first die holder (410) and the second die holder (405) and can be secured by nut (495) and lock washers (515a) and (515b). The first die holder (410) further comprises pivot arm (620). Pivot arm (620) comprises hole (615) operable to receive roller pin (455). Roller pin (455) is operable to couple with a roller (460). As shown in FIG. 3A, the adapter (415) further comprises ridges (520A) and (520B) that form groove (525). A groove (525) is operable to receive roller (455) and allow the roller (455) to travel along the length of the groove (525).

As shown in FIG. 3C, the first die holder (410) further comprises a circular portion (411). Receptacles (520) and (525) are positioned on the periphery of this circular portion (411). Receptacle (520) comprise a slot (630) operable to receive a die (465). Similarly, the receptacle (525) comprises a slot (635) operable to receive a die (480). The first die holder (410) comprises sockets (580) and (588) operable to receive hexagon socket head cap screws (475) and (490), respectively. Dies (465) and (480) are operable to receive screws (475) and (490), respectively. Screws (475) and (490) secure dies (465) and (480), respectively, to their respective slots (630) and (635).

The second die holder (405) further comprises a circular portion (406), which is preferably securely joined to the second die holder (406) by plate (407). Receptacles (530) and (535) are positioned on the periphery of circular portion (406). The first die holder (410) and second die holder (405) are coupled such that circular portions (406) and (411) are rotatably coupled to form a circular assembly where the receptacles (520, 525, 530 and 535) of first and second die holders (410, 405) are positioned on the periphery of this circular assembly. The receptacle (530) comprises a slot (640) operable to receive die (470), and the receptacle (535) comprises a slot (645) operable to receive die (485). The second die holder (405) comprises sockets (570) and (560) operable to receive hexagon socket head cap screws (650) and (655), respectively. Dies (470) and (485) are operable to receive screws (650) and (655), respectively, which secure the dies (470) and (485), respectively, to their respective slots.

As discussed above, the rod cutter (400) comprises two cutting die sets. The first die set comprises dies (465) and (470), while the second die set comprises dies (480) and (485). As also explained above, each die set is threaded and sized to fit a specific size of threaded rod. The operation of rod cutter (400) is similar to the embodiment of FIGS. 1A-2B.

Although the present invention has been discussed in considerable detail with reference to certain preferred embodiments, other embodiments are possible. The steps disclosed for the present methods are not intended to be limiting nor are they intended to indicate that each step depicted is essential to the method, but instead are exemplary steps only. Therefore, the scope of the appended claims should not be limited to the description of preferred embodiments contained in this disclosure.

What is claimed is:

1. A rod cutter comprising:
a) a first die holder comprising:
(i) a first receptacle operable to reversibly retain a first member of a first cutting die set, wherein the first cutting die set further comprises a second member, the first and second members of the first cutting die set each comprising an engagement surface operable to couple with an outer surface of a first rod having a first diameter; and
(ii) a second receptacle operable to reversibly retain a first member of a second cutting die set, wherein the second cutting die set further comprises a second member, the first and second members of the second cutting die set each comprising an engagement surface operable to couple with the outer surface of a second rod having a second diameter; and
b) a second die holder comprising:
(i) a first receptacle operable to reversibly retain the second member of the first cutting die set; and
(ii) a second receptacle operable to reversibly retain the second member of the second cutting die set,
wherein the first die holder is rotatably coupled to the second die holder so that the first receptacles of each of the first and second die holders can be aligned to form a first slot into which the first rod can be inserted and so that the second receptacles of each of the first and second die holders can be aligned to form a second slot into which the second rod can be inserted.

2. The rod cutter of claim 1, wherein the first member of the first cutting die set and second member of the first cutting die set comprise a threaded surface for coupling to a threaded rod of a first size; and
the first member of the second cutting die set and second member of the second cutting die set comprise a threaded surface for coupling to a threaded rod of a second size.

3. The rod cutter of claim 2, wherein the first and second die holders each have a circular periphery, and wherein the first and second receptacles of each of the first and second die holders are positioned around the circular peripheries of the first and second die holders.

4. The rod cutter of claim 3, wherein the pivot arm is coupled to the first die holder via an adapter and wherein rotation of the adapter causes the first die holder to rotate relative to the second die holder.

5. The rod cutter of claim 4, further comprising a handle coupled to the adapter, wherein rotation of the handle rotates the adapter.

6. The rod cutter of claim 5, further comprising:
a main base coupled to the second die holder for placement on a work surface; and
a pipe plate extending from the main base and operable to be secured to the work surface.

7. The rod cutter of claim 6, wherein the main base comprises a mounting hole.

8. The rod cutter of claim 6, wherein the pipe plate comprises a mounting hole.

9. A method of cutting threaded rods using the rod cutter of claim 1, comprising the steps of:
a) rotating the first die holder relative to the second die holder to move the first receptacle of the first die holder into a position of substantial alignment with the first receptacle of the second die holder to thereby form the first slot operable to receive the first rod and to move the second receptacle of the first die holder into a position of substantial alignment with the second receptacle of the second die holder to form the second slot operable to receive the second rod;
b) disposing the first rod within the first receptacles of the first and second die holders;
c) rotating the first die holder relative to the second die holder so as to move the engagement surfaces of the first and second cutting dies towards each other and cut the first rod;
d) disposing the second rod within the second receptacles of the first and second die holders; and
e) rotating the first die holder relative to the second die holder so as to move the engagement surfaces of the first and second cutting dies towards each other and cut the second rod.
